SEQUENCE LISTING (10 sequences)

SEQ ID NO: 1 - DNA, 34 bp, Artificial Sequence
  DEMO COMPARATIVE SEQUENCE
aattccgcaaaattacagaattttatgggtgggg

SEQ ID NO: 2 - DNA, 34 bp, Artificial Sequence
  DEMONSTRATIVE COMPARATIVE SEQUENCE
atttccgcagaattggagaattatatgggaggag

SEQ ID NO: 3 - DNA, 34 bp, Artificial Sequence
  DEMONSTRATIVE COMPARATIVE SEQUENCE
atttcagcaaacttccagaattatatgcgtgggg

SEQ ID NO: 4 - DNA, 34 bp, Artificial Sequence
  DEMONSTRATIVE COMPARATIVE SEQUENCE
cattccccaaaaatacagtatattatgggtgggg

SEQ ID NO: 5 - DNA, 34 bp, Artificial Sequence
  DEMONSTRATIVE COMPARATIVE SEQUENCE
aataccgccaaaaaaaagaattttatgggtgggg

SEQ ID NO: 6 - DNA, 34 bp, Artificial Sequence
  DEMONSTRATIVE COMPARATIVE SEQUENCE
aattcccaaacttacacgaaattttatggatggg

SEQ ID NO: 7 - DNA, 11 bp, Artificial Sequence
  DEMONSTRATIVE COMPARATIVE SEQUENCE
cgagaataatg

SEQ ID NO: 8 - DNA, 11 bp, Artificial Sequence
  DEMONSTRATIVE COMPARATIVE SEQUENCE
cgagagtaatg

SEQ ID NO: 9 - DNA, 16 bp, Artificial Sequence
  DEMONSTRATIVE COMPARATIVE SEQUENCE
aatcatctagctatga

SEQ ID NO: 10 - DNA, 16 bp, Artificial Sequence
  DEMONSTRATIVE COMPARATIVE SEQUENCE
gctcgtccgtctgtaa

(19) United States
(12) Patent Application Publication
(10) Pub. No.: US 2018/0276333 A1
(43) Pub. Date: Sep. 27, 2018

(54) CONVOLUTIONAL ARTIFICIAL NEURAL NETWORKS, SYSTEMS AND METHODS OF USE

(71) Applicant: Genetic Intelligence, Inc., New York, NY (US)

(72) Inventors: eMalick G. Njie, Brooklyn, NY (US); Bertrand T. Adanve, New York, NY (US)

(21) Appl. No.: 15/820,243

(22) Filed: Nov. 21, 2017

Related U.S. Application Data
(60) Provisional application No. 62/425,208, filed on Nov. 22, 2016.

(51) Int. Cl. G06F 19/18; G06F 19/28; G06F 19/22; G06F 19/24; G06N 3/04

(52) U.S. Cl. CPC G06F 19/18; G06F 19/28; G06N 3/04; G06F 19/24; G06F 19/22

(57) ABSTRACT

The present application discloses an image-based computational and genetic framework for creating and using maps of genetic features which can be used to identify genetic features associated with a defined characteristic.

### CROSS-REFERENCE

This application claims benefit of U.S. Provisional Patent Application No. 62/425,208, filed Nov. 22, 2016, which is incorporated herein by reference in its entirety for all purposes.

### FIELD OF THE INVENTION

This invention relates to compositions, systems and methods for discovery of complex traits using data from cohorts of populations.

### BACKGROUND OF THE INVENTION

In the following discussion certain articles and processes will be described for background and introductory purposes. Nothing contained herein is to be construed as an “admission” of prior art. Applicant expressly reserves the right to demonstrate, where appropriate, that the articles and processes referenced herein do not constitute prior art under the applicable statutory provisions.

Artificial neural networks (ANNs) are machine learning systems that learn from and make predictions on data. ANNs are biologically-inspired networks of artificial “neurons” configured to perform specific tasks. An ANN comprises a group of nodes, or artificial “neurons”, that are interconnected in a manner similar to the network of physical neurons in a brain. ANNs have the capacity to run computer-operated simulations to perform certain specific tasks like clustering, classification, pattern recognition etc. ANNs are constructed using a computational approach based on a collection of interconnected individual intercomputational nodes, e.g., neural units. ANNs model the analytical processes of the human brain with large clusters of biological neurons connected by axons. ANNs are self-learning and function by learning how to solve a given problem from a set of data provided as an initial training. Trained ANNs are able to reconstruct and model the rules underlying a given set of data.

Conventional ANNs have been used in scientific research for various applications, such as to identify genetic variants relevant to diseases and to identify genes as drug targets in the genome. For example, Coppedè et al. used ANNs to investigate metabolism changes in subjects with Alzheimer's disease by analyzing a dataset of genetic and biochemical variables obtained from late-onset Alzheimer's disease patients and matched controls to predict the status of Alzheimer's disease. (PLOS ONE, August 2013, 8:8, e74012). The study also constructed a semantic connectivity map to offer some insight regarding the complex biological connections among the studied variables to link to Alzheimer's disease. ANNs were applied in predicting binding motifs of proteins (Skolnick et al., U.S. Pat. No. 5,933,819), analyzing genotyping (Kermani, U.S. Pat. No. 7,467,117 B2), and analyzing the gene expression profile of the cells (U.S. Pat. No. 7,297,479 B2).

The present disclosure improves upon and greatly expands the applicability of ANNs by using an image-based convolutional ANN (“CANN”) to better analyze data.

### SUMMARY OF THE INVENTION

This Summary is provided to introduce a selection of concepts in a simplified form that are further described below in the Detailed Description. This Summary is not intended to identify key or essential features of the claimed subject matter, nor is it intended to be used to limit the scope of the claimed subject matter. Other features, details, utilities, and advantages of the claimed subject matter will be apparent from the following written Detailed Description including those aspects illustrated in the accompanying drawings, and as set forth in the examples and appended claims.

The present application discloses a computational and genetic framework for creating and using maps of genetic features to identify genetic features associated with a defined characteristic. These computation frameworks are created using symbols (e.g., images or sounds) representative of nucleic acid sequence data from multiple cohorts, including cohorts of individuals. Such cohorts may include individuals of a same species or subspecies, as well as cohorts of different species of highly related organisms, e.g., organisms from different species within a genus. In certain preferred aspects, these computational frameworks are created using data from at least two or more, preferably at least three or more cohorts of individuals.

In specific aspects, the disclosure provides creation and use of computational frameworks based on a convolutional artificial neural network (CANN) to extract and analyze information from nucleic acid sequences of individuals from different cohorts. These layered CANNs provide the ability to analyze genetic features of tens, hundreds, thousands, tens of thousands, hundreds of thousands to even millions of separate individuals to identify the location of the genetic features associated with (e.g., causative of) a particular phenotype. The CANNs of the disclosure use machine learning computational techniques to extract and analyze image information derived from nucleic acid sequence data, including genome sequence data.

In one aspect, the disclosure provides convolutional artificial neural networks (CANN) for identifying phenotype-causing nucleic acid sequences in living organisms. The CANN can be created by extracting features of nucleic acid sequencing data, converting sequence data of the extracted and stacked nucleic acid sequencing data to symbolic matrices, generating symbols of the sequencing data, and providing the generated symbols as input to create the CANN. In certain specific aspects, the features of the nucleic acid sequencing data are extracted using stacking of the sequencing data. In more specific aspects, the features of the nucleic acid sequencing data are extracted using pooling or stacking of the sequencing data.

The extracted data is optionally converted to symbolic integers prior to conversion to symbolic matrices. In some aspects, the symbolic matrices are visual matrices, e.g., color matrices.

Preferably, the CANN of the present disclosure comprises sequencing data from two or more cohorts, more preferably sequencing data from three or more cohorts. The sequencing data can be intergenerational, ultragenerational, or both, and can include data from two or more or three or more genetic subgroups.

The invention also includes systems for the identification of genetic features comprising the CANNs of the disclosure.

The disclosure also provides methods for identifying phenotype-causing nucleic acid sequences in living organisms. The methods can include extracting features of nucleic acid sequencing data, converting sequence data of the extracted and stacked nucleic acid sequencing data to symbolic matrices, generating representative symbols of the sequencing data, and providing the generated representative symbols as input for convolutional artificial neural networks (CANNs) to identify and extract genetic features of genome sequencing data that are causal, proximal, or otherwise of interest.

In specific aspects, the sequencing data used in the methods of the disclosure is stacked or pooled. Preferably, the methods use sequencing data from two or more cohorts, more preferably sequencing data from three or more cohorts. The sequencing data can be intergenerational, ultragenerational, or both, and can include data from two or more or three or more genetic subgroups.

In certain methods, the extracted data is converted to symbolic integers prior to conversion to symbolic matrices. In specific aspects, the symbolic matrices are visual matrices, e.g., color matrices.

In specific aspects, the disclosure provides a method for creating first generation cSNP genetic images comprising stacking nucleic acid sequencing data from at least two different cohorts, converting the bases of the nucleic acid sequencing data to symbolic integers, converting the symbolic integers to symbolic matrices to form a matrix of layering of individual genomes, and inserting artificial genetic features to the matrix as arbitrary symbolic values that represent the ideal layering of the nucleic acids by orienting known genetic features. These symbolic images are preferably visual matrices, e.g. color matrices. For example, the matrices are converted to pixel space with a color mask.

In a specific aspect, the disclosure provides methods for generating adaptive curated single nucleotide polymorphism (cSNP) maps utilizing genome sequences from at least two cohorts of individuals, preferably three or more cohorts of individuals. The cSNP maps can be used to identify genetic variants associated with a phenotype in the genomes of organisms.

These and other aspects, features and advantages will be provided in more detail as described herein.

### BRIEF DESCRIPTION OF THE FIGURES

FIG. 1 is a schematic view illustrating the use of CANNs to extract genetic features of whole genome sequencing data. FIG. 1 presents the following nucleic acid sequences:

SEQ ID 1: AATTCCGCAAAATTACAGAATTTTATGGGTGGGG
SEQ ID 2: ATTTCCGCAGAATTGGAGAATTATATGGGAGGAG
SEQ 1D 3: ATTTCAGCAAACTTCCAGAATTATATGCGTGGGG
SEQ ID 4: CATTCCCCAAAAATACAGTATATTATGGGTGGGG
SEQ ID 5: AATACCGCCAAAAAAAAGAATTTTATGGGTGGGG
SEQ ID 6: AATTCCCAAACTTACACGAAATTTTATGGATGGG

FIG. 2 is a schematic view to define the binary state of a curated single nucleotide polymorphism (cSNP). FIG. 2 presents the following nucleic acid sequences:

SEQ ID 7: CGAGAATAATG
SEQ ID 8: CGAGAGTAATG

FIG. 3 is a first generation cSNP genetic image. FIG. 3 presents the following nucleic acid sequences:

| | |
|---|---|
| SEQ ID 9: | AATCATCTAGCTATGA |
| SEQ ID 10: | GCTCGTCCGTCTGTAA |

FIG. 4 is a second generation cSNP genetic image.

FIG. 5 is a schematic view to illustrate the use of CANNs to generate cSNP maps, wherein the CANNs are fed with cSNP genetic images. FIG. 5 presents the following nucleic acid sequences:

| | |
|---|---|
| SEQ ID 9: | AATCATCTAGCTATGA |
| SEQ ID 10: | GCTCGTCCGTCTGTAA |

### DETAILED DESCRIPTION OF THE INVENTION

The following description is presented to enable one of ordinary skill in the art to make and use the invention and is provided in the context of a patent application and its requirements. Various modifications to the exemplary embodiments and the genetic principles and features described herein will be readily apparent. The exemplary embodiments are mainly described in terms of particular processes and systems provided in particular implementations. However, the processes and systems will operate effectively in other implementations. Phrases such as “exemplary embodiment”, “one embodiment” and “another embodiment” may refer to the same or different embodiments.

The exemplary embodiments will be described with respect to methods and compositions having certain components. However, the methods and compositions may include more or less components than those shown, and variations in the arrangement and type of the components may be made without departing from the scope of the invention.

The exemplary embodiments will also be described in the context of methods having certain steps. However, the methods and compositions operate effectively with additional steps and steps in different orders that are not inconsistent with the exemplary embodiments. Thus, the present invention is not intended to be limited to the embodiments shown, but is to be accorded the widest scope consistent with the principles and features described herein and as limited only by appended claims.

It should be noted that as used herein and in the appended claims, the singular forms “a,” “and,” and “the” include plural referents unless the context clearly dictates otherwise. Thus, for example, reference to the effect of “a neuron” may refers to the effect of one or a combination of neurons, and reference to “a method” includes reference to equivalent steps and processes known to those skilled in the art, and so forth.

Where a range of values is provided, it is to be understood that each intervening value between the upper and lower limit of that range—and any other stated or intervening value in that stated range—is encompassed within the invention. Where the stated range includes upper and lower limits, ranges excluding either of those limits are also included in the invention.

Unless expressly stated, the terms used herein are intended to have the plain and ordinary meaning as understood by those of ordinary skill in the art. The following definitions are intended to aid the reader in understanding the present invention, but are not intended to vary or otherwise limit the meaning of such terms unless specifically indicated. All publications mentioned herein are incorporated by reference for the purpose of describing and disclosing the formulations and processes that are described in the publication and which might be used in connection with the presently described invention.

Those skilled in the art will recognize, or be able to ascertain using no more than routine experimentation, many equivalents to the specific embodiments of the invention described herein in the detailed description and figures. Such equivalents are intended to be encompassed by the claims.

For simplicity, in the present document certain aspects of the invention are described with respect to genes associated with diseases or disorders. It will become apparent to one skilled in the art upon reading this disclosure that the invention is not intended to be limited to use in disease gene identification, and can be used to identify genes associated with various phenotypes in any or all species.

### Definitions

The terms used herein are intended to have the plain and ordinary meaning as understood by those of ordinary skill in the art. The following definitions are intended to aid the reader in understanding the present invention, but are not intended to vary or otherwise limit the meaning of such terms unless specifically indicated.

The term “cohort” as used herein is a group of one or more subjects identified by a phenotypic characteristic.

The term “convolutional artificial neural network” or “CANN” as used interchangeably herein refers to a multilayered, interconnected neural unit collection in which the neural unit processes a portion of receptive fields (e.g., for inputting images). CANNs can be based on a computational algorithmic architecture in which the connectivity patterns between the neural units model the analytical processes of the visual cortex of the brain in processing visual information. The neural units in CANNs are generally designed and arranged to respond to overlapping regions of the receptive field for image recognition with minimal amounts of preprocessing to obtain a representation of the original image. CANNs in the literature can utilize reconfigurations of component parts (e.g., hidden layers, connections that jump between layers, etc.) to improve representations of the input data. One example of CANN construction can be found in Krizhevsky et al., ImageNet Classification with Deep Convolutional Neural Networks Advances in Neural Information Processing Systems 25 (NIPS 2012).

The term “curated SNP” or “cSNP” as used interchangeably herein, refers to a curated single nucleotide polymorphism (cSNP) and is defined as a type of SNP which is curated by intentional collection of data (e.g., whole genome sequencing data) from distinguishable populations of subjects (e.g., mammals wild-type for a particular disease or disorder versus mammals affected with the disorder and within whom genetic linkage is measurably changed from wildtype). cSNPs can be used to identify genes with changes in size, use and/or function and therefore are powerful tools to identify genes that cause phenotypes (e.g., genes that cause inherited diseases).

The term “genetic features” as used herein includes any feature of the genome, including sequence information, epigenetic information, etc. that can be used in the methods and systems as set forth herein. Such genetic features include, but are not limited to single nucleotide polymorphisms (“SNPs”), curated (“cSNPs”), insertions, deletions, codon expansions, methylation status, translocations, duplications, repeat expansions, rearrangements, copy number variations, multi-base polymorphisms, splice variants, etc.

The term “genetic subgroup” means a population of individuals of one or a related number of species that share certain defined genotypic features. The genetic subgroup can be defined by inclusion of one or more genetic feature, and an individual can belong to several genetic subgroups. The genetic subgroups may be more or less distinct, depending on how many genetic features are used and how much overlap there is with other subgroups.

The term “ultragenerational” refers to an analysis in which the data is generation and/or lineage agnostic. For example, the term encompasses analysis using unrelated individuals and different subgroups of the same generation.

The term “intergenerational” refers to an analysis using knowledge of two or more generations of an affected individual's family history of the disease.

“Nucleic acid sequencing data” as used herein refers to any sequence data obtained from nucleic acids from an individual. Such data includes, but is not limited to, whole genome sequencing data, exome sequencing data, transcriptome sequencing data, cDNA library sequencing data, kinome sequencing data, metabolomic sequencing data, microbiome sequencing data, and the like.

A “phenotype” is any observable, detectable or measurable characteristic of an organism, such as a condition, disease, disorder, trait, behavior, biochemical property, metabolic property or physiological property.

The term “state neurons” refer to the neural units of an ANN, including a CANN, that have computed their state by filtering the incoming inputs multiplied by its corresponding connection weight. The state neurons of the present invention are a novel feature of the CANNs of the present disclosure, as the representation of the data as manifested in the state neurons provide the CANNs with their unique ability to efficiently identify causal genetic features and generate genetic feature maps

A “symbolic matrix” as used here refers to a series of symbolic representations of sequencing data for use in the CANNs of the present disclosure. Such representations include images, sounds, or other elements that are indicative of the specific sequencing data and that can be used to distinguish genetic features between cohorts.

### The Invention in General

The present invention discloses a computational and genetic framework for generating genetic feature maps which can be used to identify the genes that code for a phenotype or set of phenotypes. Although previously CANNs were widely applied in image recognition to extract visual information, the invention utilizes these CANNs in a novel fashion to allow visual analysis of nucleic acid sequence information. The computational framework of the present application is based on CANNs with machine learning computational techniques to extract and analyze information from genome sequences, in which the CANNs are trained with genetic “images” containing two or more genetic features.

In some aspects a computer method is employed to facilitate extraction of the causal nucleic acid sequences from the sequencing data. See, e.g., Li H et al., Bioinformatics. 2009 Aug. 15; 25(16): 2078-2079. The extraction of the information on nucleic acid sequences and genetic features can identify changes in the data based on, e.g., changes in the sequencing data from one, two, or an admixture of the cohorts used in the analysis, or as compared to a reference sequence as introduced to the CANN for the analysis.

In specific aspects, various artificial intelligence applications can be provided to identify causal genetic features based on the state neurons. These applications can render genetic feature detection and proximity determination automatic and/or programmable.

Once a region of interest in the sequencing data has been identified using the CANN, a genetic feature detection step is initiated. The relationship of the causal genetic feature to changes in the sequencing data between cohorts or as compared to a reference may identify a change as part of the gene or feature (i.e., not in the protein coding genome), but it could also identify the proximity of a change to a predicted causal genetic feature.

Once a proposed causal genetic feature has been identified, the associated region of interest from the sequencing data is examined for any additional changes. One approach for doing so is employment of a variant caller against the human genome reference and/or other controls. Oftentimes, but not always, the genetic feature with the highest signal occurs in the causal region.

The ability to utilize ultragenerational datasets in the CANN of the present disclosure allows the elucidation of genetic features associated with characteristics in an unprecedented fashion. While earlier usages of ANNs would range from approximately 1000-110,000 individual sequence “profiles”, (Zhoe J et al., Nat Methods. 2015 October; 12(10):931-4; Chien et al., Bioinformatics, Volume 32, issue 12, 15 Jun. 2016, Pages 1832-1839), the CANNs of the present disclosure utilize different informational input that allows for creation of the state neurons.

Utilizing ultragenerational data sets is a critical improvement in the present disclosure, as use of ultragenerational data sets does not require records of the information on members of the cohorts in different generations, which may be difficult to obtain. For example, the needed genotypic and/or phenotypic state may not be available for many family members as used in intergenerational data analysis. This is especially true for humans, since the family inheritance cannot be controlled as in model organisms, the time between generations can be fairly long, and the recorded familial relationships may not be correct (e.g., paternity of one or more family member may be in question). In addition, although multifactorial and/or polygenic disorders often cluster in families, they generally do not display a clear pattern of inheritance. Thus, the ability to use ultragenerational data allows an unprecedented analysis approach for discovery of genetic features associated with complex inherited traits.

Deep convolutional neural networks are capable of achieving results in processing images on highly complex datasets using purely supervised learning. The compositions and methods of the present disclosure can be used, for example to identify disease-causing genes from human genomes, including genes involved in polygenic inheritance; to identify responders to specific treatments as well as for providing early treatment for combatting or even curing such diseases; or to identify variants in metabolism that predict the toxicity of a treatment on a cohort of individuals. Accordingly, the present way of training the CANN is unique and significantly different than what would have been generally done or applied in the art.

Almost all neural networks are trained but there are decision points about what data is applied to the network, what will be the arrangement of neurons/nodes, how will the feedback to adjust weights work, and how many times the network is iterated in training, validation and testing modes to reduce error and increase specificity to features in general and features of interest. In the present disclosure, the creation of the state neurons of the ANNs allows the neural networks to effectively determine which genetic features are potentially causal as compared to genetic changes in the data that are likely not correlative or are due to technical mistakes, e.g., sequencing changes due to sequencing and/or amplification errors.

One of the advantages of the embodiments of the present disclosure is that a genetic feature map (e.g., a cSNP map) can be constructed in a relatively short time frame (hours) compared to previous approaches of creating cSNP maps which were error prone.

For example, rudimental cSNP maps have been created for the nematode C. elegans. The creation of such maps is slow and error prone. For instance, creation of the C. elegans cSNP map occurred around 2001, and was created manually using a programming stack principled on RepeatMasker, wu-BLAST, and PolyBAYES. (Wicks et al., Nat Genetics, 2001 June; 28(2):160-4). Although this map identified thousands of predicted polymorphisms, the data included flaws and required further years of work to finally confirm the cSNPs and increase usefulness of the data. The laboratory of Oliver Hobert reduced the number of cSNPs in this map to ˜96,000 to make the map finally useful (Minevich G. et al., Genetics, 2012 December; 192(4):1249-69).

The genetic images used in the present application to train CANNs are individual unique images and are automatically created in the millions of different arbitrary sequences provided to the CANN using the computational method of the present application. The invention includes the genetic feature images, e.g., the curated single nucleotide polymorphism (cSNP) genetic images, generated by the methods disclosed herein.

Another advantage of the present application is that the genetic feature maps of the present application are adaptive. Often conventional cSNP maps, such as the C. elegans cSNP map, are static and limited to comparison of the specific data utilized in the creation of the cSNP map. For example, the cSNP map of C. elegans genomes in Hawaii, USA and Bristol, England cannot be generalized to compare to genomes in other places of the world. In the present application, the pre-trained CANNs with state neurons can recognize the state of DNA base pair comparisons. Therefore by definition it is dynamic and can be adapted to different regions of the world. For example, whole genome sequencing data from any two regions of the world for any species can be inputted and the output is a novel cSNP map particular to that region.

The teachings of the present disclosure also allow the recognition of cSNPs with specific sub-threshold activation. The conventional cSNP maps are reliant on absolute binary states of 0 and 1. CANNs consist of multiple layers, with the signal path traversing from front to back. The training of a CANN with genetic images selects for neurons responsive to these absolute states. Once these neurons are trained, however, they can be identified within the CANN using back propagation and their activation threshold lowered programmatically. Back propagation is the use of forward stimulation to reset weights on the front neural units.

For example, a potential cSNP exists at a specific position of the C. elegans genome in Hawaii that is base A in 0% of individuals, thus giving it a 0 state. In C. elegans genome in Bristol, England, it is base T in 70% of individuals, and base G in 30% of individuals. Because it is not 100% base T, it will not be recognized as a 1 state and that position will not be considered a cSNP.

In the CANNs of the present disclosure, the cSNP sensitive state neuron can be instructed to have sub-threshold activation enabling the firing when it comes across this position. This results in better recognition of cSNPs with increased overall density and resolution of the cSNP map. Moreover, these CANNs have the ability to include data from more than two different genetic subgroups or cohorts into a cSNP map.

Importantly, the CANNs and methods as described herein allow identification of causal genetic features (e.g., causal cSNPs) in complex sequence data e.g., data from whole genome sequencing of cohorts of diverse, non-inbred organisms (e.g., humans). The visual analysis framework of the CANNs provides the ability to overcome issues due to the high dimensionality and/or noise along the entire length of such genomes.

This high dimensionality and/or “noise” may include, but is not limited to, variations within genomes of individuals in cohorts that have greater variation from a reference genome, sequence variations introduced experimentally and the like.

One approach to reduce “noise” is through inbred studies. Inbred studies are those where subjects have mated repeatedly with family members. This can be done intentionally, such as in model organisms, where generations of offspring are recursively mated to their parents. Studies with inbred populations can also choose to sample a group of individuals that for reasons including culture or geographical isolation, have mated with close relatives. Examples include Ashkenazi Jews and certain other tribes in Middle Eastern countries. Inbreeding can be employed to reduce dimensionality in the genome such that most positions are homozygous. It is effectively a noise reduction technique. However, inbreeding is limited because most individuals of a species are typically not inbred as severe genetic disorders and death often occurs in overly inbred individuals.

In contrast, a heterozygous genome carries along its entire length “noise” that frustrates isolation of genetic features that cause a phenotype. Most individuals of sexually reproducing species are outbred, and the heterozygous state of the genomes means that at any given position it can be difficult to determine which feature is responsible for a phenotype. Moreover, positions away from the position of interest also are heterozygous and depending on the individual being observed, there is a non-trivial likelihood of there being other genetic variations within a region of interest. But the ultragenerational aspect of the present disclosure can uniquely take advantage of the high dimensionality of heterozygous states of outbred genomes to identify causal genetic features.

In certain aspects, the methods disclosed herein can be used for diagnosis and monitoring of a genetic disorder. Genetic disorders can be typically grouped into two categories: single gene disorders and multifactorial and/or polygenic disorders. A single gene disorder is the result of a single mutated gene. Genetic disorders may also be multifactorial and/or polygenic, meaning that the disorder is associated with the effects from multiple genes, often in combination with lifestyle and other environmental factors. Although multifactorial and/or polygenic disorders often cluster in families, they generally do not display a clear pattern of inheritance. This makes it difficult to determine a risk of inheriting or passing on these disorders. Complex disorders are also difficult to study and treat because the specific factors that cause most of these disorders have not yet been identified. The compositions and methods of the present disclosure are particularly suited for the identification of nucleic acid sequence alterations that are associated with (e.g., causative of) polygenic and/or multifactorial disorders.

### Convolutional Artificial Neural Networks

The present disclosure improves upon and greatly expands the applicability of ANNs by using an image-based convolutional ANN (“CANN”) to better analyze intergenerational and/or ultragenerational data.

CANNs are neural networks created from a sequence of individual layers, with each successive layer operating on data generated by a previous layer. The layers of the CANNs of the present disclosure execute one or more specific operations that allows for the creation of the state neurons. In some systems, the artificial neural network is provided using extracted sequence data from the nucleic acids of various individuals to provide information on two or more, preferably three or more cohorts. Certain implementations of the novel CANNs of the disclosure can use the machine learning dimensional reduction technique (e.g., using unsupervised learning on genetic symbolic matrices) to segregate different features which can be used to train the CANN.

The computational framework of the invention uses input symbols (e.g. images) and machine learning computational techniques to extract and analyze information from nucleic acid sequences. The present application discloses methods to find and identify genetic features that are linked to phenotype-causing mutations and to identify the causal variants. The present methods are further advantageous because they are based on genetic linkages and causation rather than by general correlations.

CANNs are created from a sequence of individual layers, with each successive layer operating on data generated by a previous layer. The layers of the CANNs of the present disclosure execute one or more specific operations that allows for the creation of the state neurons. For instance, the neurons in CANNs are fundamentally ensembles of linear regressions that are squashed into a non-linear representation with a sigmoid function. This gives a probability between 0 and 1. Each neuron is given an arbitrary weight and algorithms such as gradient descent are used together with a cost function to discover which neuron(s) were closest to matching the training data. Repetitions of this occur across layers, with each becoming more rarified and holding deeper representations of the input data. In the final layer, a softmax function is used to decide which neurons carry the most useful (closest to training data) representation.

In some systems, the artificial neural network is provided extracted sequence data from the nucleic acids of various individuals to provide information on two or more, preferably three or more cohorts of subjects having a specific characteristic, e.g., phenotype. The CANN executes a series of convolutions of the image data with multiple weight maps. The number of images generated by the series of convolutions is determined by the number of weight maps with which the image data is convolved. Subsequently, the artificial neural network module applies a nonlinear function to the image data generated by the series of convolutions.

Accordingly, in some aspects, an artificial neural network system of the disclosure implements a deep convolution artificial neural network configured to classify images depicted within image data into classes corresponding to spatial regions associated with the genetic features (e.g., a genome or a transcriptome).

In some examples, the convolutional artificial neural network system is configured by executing a backpropagation process based on the training data. In this way, the artificial neural network module executes a search for weight map parameters that best classify all of the training data. The design of the system's architecture may specify a number of parameters including a number of layers, a number of weight maps per layer, values of the weight maps, nature of the data extraction performed; whether contrast normalization is done, the type of stacking and/or pooling performed, etc. For example, in certain aspects stacking is performed so that the data associated with an individual's data is preserved.

In certain aspects, the systems of the disclosure include a standard neural network architecture, such as the architecture described by Krizhevsky, A., Sustkever, I., and Hinton, G. E. in “ImageNet Classification with Deep Convolutional Neural Networks,” NIPS, 2012, although any number of other neural network architectures can be used. See. E.g., Van Veen F, An Informative Chart, to Build Neural Network Cells, 2016; asimovinstitute.org; see also Visualizing and Understanding Convolutional Networks, European Conference on Computer Vision 2014, pp 818-833.

The genetic images of the present application are layered as they would be, e.g., in whole genome sequencing data by converting the genetic image to the style of MNIST digit pixel space. These genetic images are individual unique images and are automatically created in the millions as needed by CANNs using the computational method of the present application. The pre-trained CANNs fire neurons at positions where genetic features occur. The map of the CANN firing is a cSNP map.

In one aspect, the present application discloses creation of a CANN by extracting features of genome sequencing and stacking genome sequencing data; converting DNA bases of the stacked genome sequencing data to symbolic integers; converting the integers to symbolic matrices to generate representative symbols of genome sequencing data; and providing the generated images as input for convolutional artificial neural networks (CANNs) to identify and extract features of genome sequencing data.

In a specific aspect, the genetic features used are single nucleotide polymorphisms, e.g., curated single nucleotide polymorphisms that are recognized in genetic images. Genetic variations in SNPs may indicate the individual's susceptibility to disease, severity of illness, and responses to treatments. For example, a single base mutation in the apolipoprotein E (APOE) gene is indicative for higher risks of Alzheimer's disease, and a single base mutation in the LRRK2 gene is associated with familial Parkinson's disease. Some SNPs, such as those in the BAGS locus, are associated with the metabolism of different drugs and may be important for drug safety; others are relevant pharmacogenomic targets for drug treatments. Some SNPs have been used in genome-wide association studies as high-resolution markers in gene mapping. Therefore, gene sequencing at the SNP level is useful to identify functional variants to predict disease susceptibility and find drug treatments.

In specific aspects, the method includes inserting artificial cSNPs to the matrix as symbolic arbitrary values 500 and 1000, wherein 500's and 1000's are always paired to represent the ideal layering of genome by orienting known cSNP side by side; and converting the matrix to pixel space with a symbolic color mask wherein values under 100 are converted to blue, values of 500 are converted to red, and values of 1000 are converted to green. Preferably, the cSNP genetic images are obtained by also inserting random SNPs having values of 100 and instructing the color mask to designate these values as pixels of a different color, e.g., light blue, so that the CANN is trained to recognize and identify aberrations from the matrix. The integer values 500, 1000, and so forth noted here are purely symbolic and thus readily changed to fractions for instance to represent greater gradations of complexities within genomes. Furthermore, the CANN can output data that can be visually observed due to the use of different colors or that can be converted to graphical representations.

The invention also provides methods of identifying the position of a genetic feature causal of a characteristic or phenotype within a sequence structure (e.g., the genome). The CANN including the images corresponding to the sequence data of the cohorts of individuals is trained to recognize and identify variants in the sequence information, and new information on the genetic feature or known positions information can be provided to the CANN. The CANN can then produce an output which provides the information on a potentially causal genetic feature, e.g., a cSNP associated with a disease state.

In yet another aspect, the computer-implemented method generates an adaptive curated single nucleotide polymorphism (cSNP) map, by training a convolutional artificial neural network (CANN) with various genetic images, with the CANN comprising at least an input layer, several hidden layers, and an output layer; separating the images by the CANN into component parts of color; feeding the separated colors to the hidden layers, wherein specific features are extracted at each hidden layer and fed into a series of subsequent hidden layers up until a fully connected hidden layer and classification layer; applying to the CANN input data characterizing at least one genome sequencing data; and analyzing the genome sequencing data by the CANN to generate a cSNP map. The cSNP map can then be used to identify regions of the genome that harbor phenotype-causing differences or mutations (e.g., disease-causing mutations).

The invention also relates to a method of identifying region(s) of a genome harboring phenotype-causing mutations and/or to identify causal variants thereof which comprises training a CANN to recognize and identify aberrations in the genome by one of the methods described herein; feeding new or additional genome information to the CANN; and receiving an output from the CANN which identifies such aberrations in the fed genome information. In particular, the CANN is trained to identify cSNP aberrations in the subject's DNA that directly demonstrate the specific DNA base and sequence region that causes hereditary diseases such as Alzheimer's disease.

The disclosure in one aspect provides CANNs to extract features of nucleic acid sequencing data using color symbols. The method of extracting such features comprises the steps of stacking and/or pooling whole genome sequencing data from two or more different genetic subgroups of humans or any other living organisms, converting the DNA bases of the whole genome sequencing data to integers, converting the integers to colors or color matrices to generate images of whole genome sequencing data, then using the generated images as input for CANNs to build adaptive cSNP maps against which and preferably with similarly converted whole genome sequencing data from individuals. In certain aspects, the CANNs use a relational reference, e.g., a provided reference from a particular species or an admixture reflective of the distinct subgroups that make-up the adaptive cSNP maps, to extract features of whole genome sequencing data. In other aspects the features are extracted from the CANNs without the need for use of a reference.

The extracted features of the whole genome sequencing data comprise unknown features and high level features, such as start codons, stop codons of gene transcription, protein coding regions, enhancer regions, silencer regions, and other regulatory, protective, and/or featured nucleic acids.

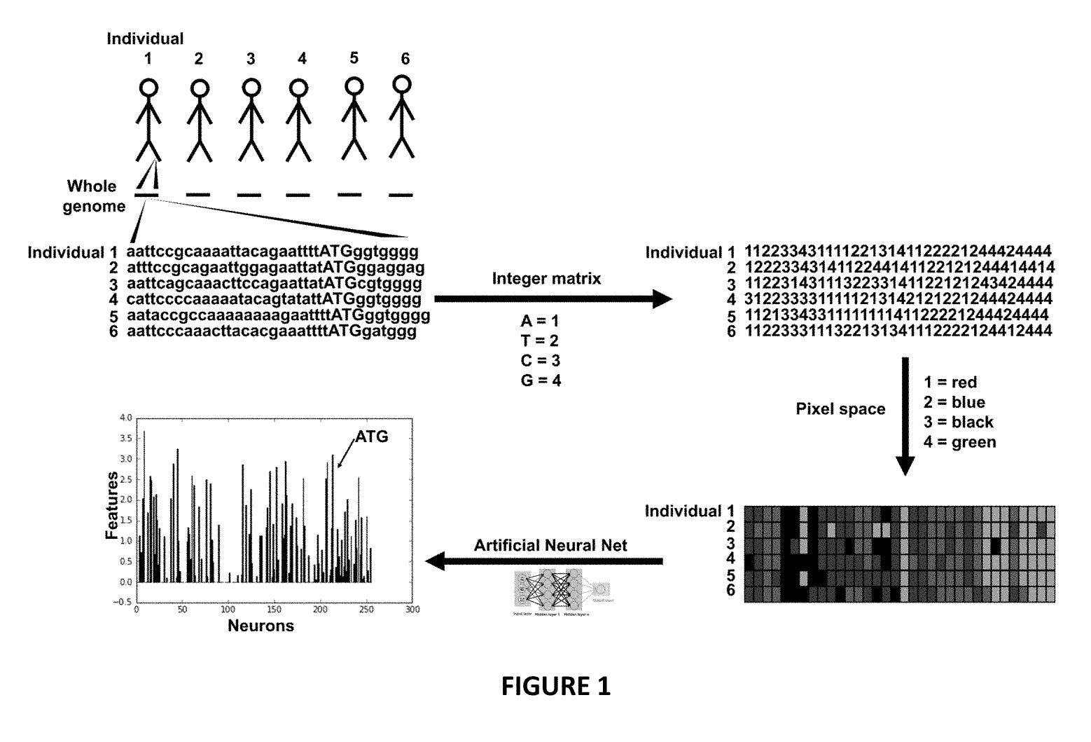

An example of this is shown in FIG. 1, which shows that the human genome can be converted from the conventional ATCG nucleotides to the symbolic integers 1, 2, 3 or 4. These numbers are then converted to colors with 1 being converted to red, 2 converted to blue, 3 converted to black and 4 converted to green. Depictions of the stacked sequence and the converted numbers and colors are also illustrated. The colored information is thus a generated graph which illustrates the positions of the different nucleotides based on the intensities and variations of the colors. Such a graph can then be passed into a CANN sensitive to visual information representations. The integers and colors are purely symbolic and thus readily changed to more useful forms as needed. For instance fractions may be used in place of integers which yield a more nuanced color pallet to represent greater gradations of complexities within genomes.

An important design architecture of the computational framework of the present application is that the value assigned to cSNPs in the genetic image can be arbitrary, but the assigned value must be continuously variable across the millions of genetic images in the training set. This ensures that neurons are not selected for sensitivity to the value but rather to the state of the cSNP. The state is what is important in recognizing cSNPs, rather than the assigned value.

The Binary State of Biallelic cSNPs:

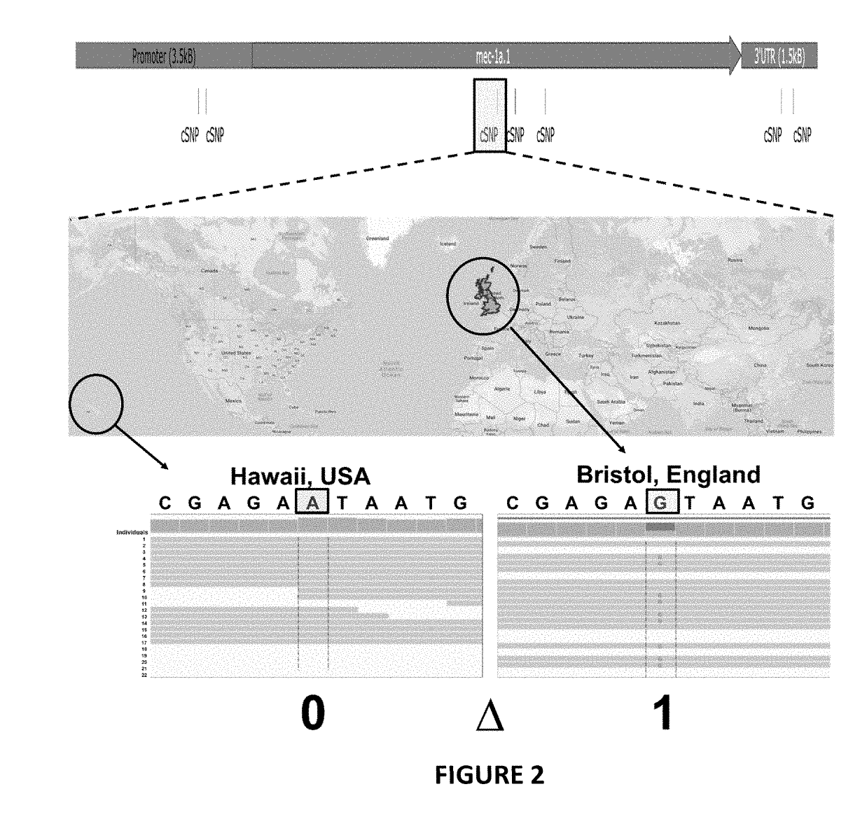

As shown generally in FIG. 2, a specific position of mec-1 gene in the C. elegans genome from Hawaii is base A, but this specific position is base G in the C. elegans genome from Bristol, England, and all other bases in nearby positions are identical. When a specific SNP is always found in the C. elegans genome from Bristol, England, but it is never found in the C. elegans genome from Hawaii, this specific SNP is annotated as a cSNP which exists in a state of “1” in the C. elegans genome from Bristol, England and in a state of “0” in the C. elegans genome from Hawaii (FIG. 2). The change in state (i.e. 0< >1) of a SNP defines a cSNP, and the actual value of the base (such as, A or G) in the specific position of the gene is irrelevant. The C. elegans cSNP map is a comparison of Hawaii, USA and Bristol, England and is considered to be a static map. At position x where the Hawaiian base is A (symbolically a “0”) and the Bristol base is G (symbolically a “1”), a new base T at the same position x of another strain of C. elegans (e.g., from China) will not be recognized in this static map as “1” though it symbolically is such if compared solely to Hawaiian or Bristol C. elegans. This logic extends to other species including human. A pre-trained CANN with state neurons are by definition dynamic as they recognize the state of DNA base pair change (A< >G==0< >1, A< >T==0< >1) and thus will resolve the T as a cSNP position. This dynamic quality extends the CANN for use to new DNA it has not been trained on for instance DNA from other species (e.g., human).

In the case of analysis of genetic disease across multiple generations, there are various cSNPs associated specifically with this genetic disease. Due to genetic recombination and linkage, a small population of cSNPs will occur at the physical location of the mutated gene, but a large population of other cSNPs which are located away from the mutated gene will disappear from the whole genome sequence data.

### Implementations

In certain implementations, the disclosure provides methods for identifying phenotype-causing nucleic acid sequences in living organisms using genome sequencing data from diverse or outbred individuals that are admixtures of two or more genetic subgroups.

In other implementations, the disclosure provides methods for identifying phenotype-causing nucleic acid sequences in cohorts of individuals using genome sequencing data from individuals that are not intergenerational. In certain specific aspects, the genetic status of one or more cohorts is not known.

In yet other implementations, the disclosure provides methods, preferably computer-implemented methods, for extracting features of genome sequencing data which comprises stacking genome sequencing data; converting DNA bases of the stacked genome sequencing data to symbolic integers; converting the integers to color matrices to generate images of genome sequencing data; and providing the generated images as input for convolutional artificial neural networks (CANNs) to identify and extract features of genome sequencing data. In specific aspects, these methods further include inserting artificial curated single nucleotide polymorphism (cSNPs) into the matrix as symbolic arbitrary values that are paired to represent ideal layering of the genome by orienting known cSNPs side by side; and converting the matrix to pixel space with a symbolic color mask, wherein a first range of values are converted to a first color, a second range of values are converted to a second color, and a third range of values are converted to a third color.

In even more specific aspects, the methods for extracting features of genome sequencing data use paired symbolic arbitrary values between 500 and 1000, wherein 500's and 1000's are paired to represent the ideal layering of the genome, and the matrix is converted to pixel space with the symbolic color mask wherein values under 100 are converted to a first color, values of 500 are converted to a second color, and values of 1000 are converted to a third color. In addition, random genetic features (e.g., SNPs) can be added by introducing symbolic values of 100 randomly and instructing the color mask to designate these values as pixels of a different color.

Preferably, the output data from these methods is visually observable due to the use of different symbolic colors or is converted to graphical representations.

Maps of CANN neurons firing that are a representative and/or an abstraction of a genetic feature map can be achieved by converting genetic data to pixel space and feeding to trained CANN and CANN fires neurons at positions where the genetic features occur or by an equivalent computer method. The genetic data is from two or more genetic subgroups, preferably three or more genetic subgroups, and in certain embodiments all from individuals of the same species or sub-species.

In yet other implementations, the disclosure provides methods, preferably computer-implemented methods, for generating an adaptive curated single nucleotide polymorphism (cSNP) map, which comprises: training a convolutional artificial neural network (CANN) with various genetic images, with the CANN comprising at least an input layer, several hidden layers, and an output layer; separating the images by the CANN into component parts of color, where different nucleotides are represented by different colors; feeding the separated colors to the hidden layers, where specific features are extracted at each hidden layer and fed into subsequent hidden layers to create a fully connected hidden layer and classification layer; applying to the CANN input data characterizing at least one genome sequencing data; and analyzing the genome sequencing data by the CANN to generate a cSNP map. The CANNs can be trained with images that are provided to the CANN, the images being created by stacking and/or pooling genome sequencing data; and introducing modifications of the genome sequencing data by randomly providing additional colors for some of the nucleotides so that the CANN is trained to recognize and identify aberrations.

In some implementations, the genetic features used to create the CANNs are binary with a blended state of 0 and 1 or subfractions thereof. An example of this is the use of biallelic cSNPs with a defined binary state of 0 and 1.

In other implementations, the genetic features used to create the CANN are genetic features with ternary states of −1, 0 and 1.

Preferably, the extraction of the causal nucleic acid sequences from the nucleic acid sequencing data used in to identify the phenotype-causing nucleic acid sequences is computer assisted.

Hardware Implementations

In certain implementations, the neural net architecture to generate state neurons capable of defining genetic features is translated to hardware, which is optionally on a system in support of a CPU. Such translation to hardware results in acceleration of the functions which can result in a significant increase in speed as compared to software implementations. For example, Artificial Intelligence (AI) Accelerators have been developed to emulate software neural nets on-chip. These stem from General Purpose Graphic Processing Units (GPGPUs) which because of their highly parallel nature, process millions of image representations more efficiently than CPUs and more closely resemble the massively parallel nature of biological neural nets. AI Accelerators extend on this by discarding traditional cannon of CPUs—for instance, removal of scalar values in IBM's TrueNorth Chip containing grids of 256 neural units (Merolla et al., Science 8 Aug. 2014, Vol. 345, Issue 6197, pp. 668-673). This chip was recently used to generate spiking neural nets (Diehl P U et al., arXiv:1601.04187v1).

The transformation of software applications to hardware accelerators is of particular relevance to the implementation of certain aspects of the invention, as the binary nature of weights and inputs in the convolution and fully connected layers can be used to generate on-chip state neurons. Rastegari et al., arXiv:1603.05279v4.

Moreover, such architecture may be extended into future iterations of quantum chips where state neurons with blended states are capable of integrating non-binary genetic features, e.g., in noisy genomes.

### EXAMPLES

The following examples are put forth so as to provide those of ordinary skill in the art with a complete disclosure and description of how to make and use the present invention, and are not intended to limit the scope of what the inventors regard as their invention, nor are the examples intended to represent or imply that the experiments below are all of or the only experiments performed. It will be appreciated by persons skilled in the art that numerous variations and/or modifications may be made to the invention as shown in the specific aspects without departing from the spirit or scope of the invention as broadly described. The present aspects are, therefore, to be considered in all respects as illustrative and not restrictive.

Efforts have been made to ensure accuracy with respect to numbers used (e.g., amounts, temperature, etc.) but some experimental errors and deviations should be accounted for. Unless indicated otherwise, parts are parts by weight, molecular weight is weight average molecular weight, temperature is in degrees centigrade, and pressure is at or near atmospheric.

### Example 1: Creation of First Generation cSNP Images

In a first implementation, CANNs were created using genetic images. DNA information was layered as it would be in whole genome sequencing data by converting the genetic image to the style of MNIST pixel space. The MNIST (Mixed National Institute of Standards and Technology) database is defined as a series of images of handwritten digits. The digits range from 0 to 9 with different handwriting styles. The digital space of the data in MNIST has been normalized, such as in pixel arrays of 28×28. When a computer algorithm reads an image of handwritten digits, MINST database can be used to predict the intended digits in the image.

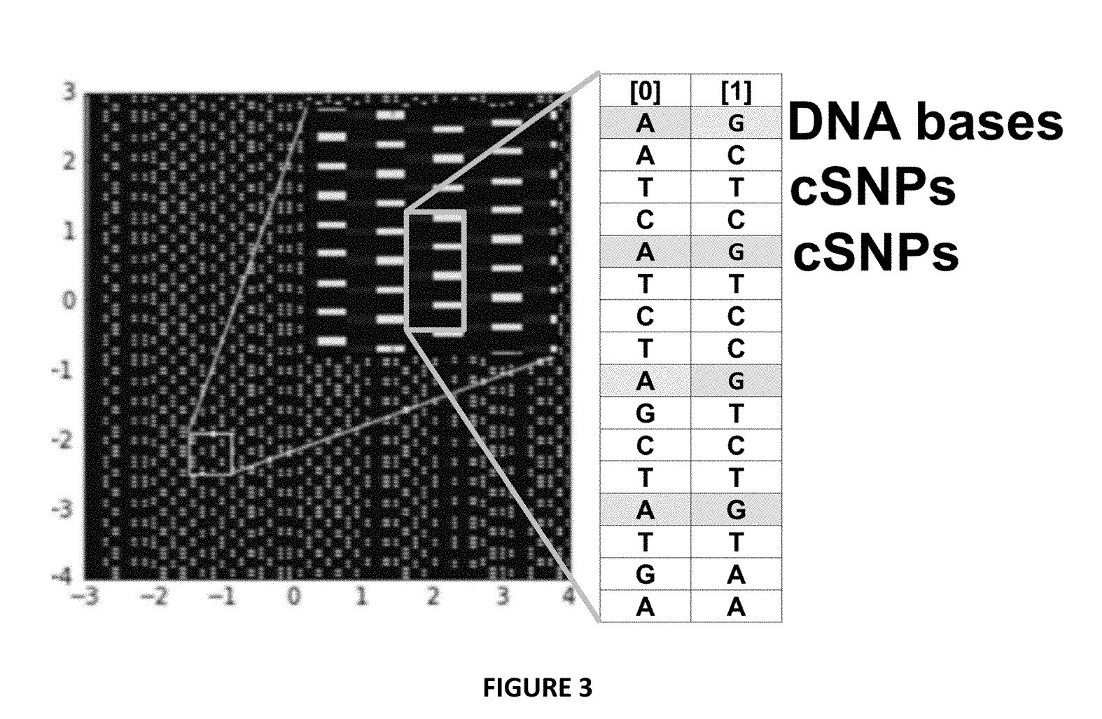

The method of creating first generation cSNP genetic images used the steps of: pooling genome sequencing data from C. elegans; converting the DNA bases of the genome sequencing data to symbolic integers (such as, A=1, T=2, C=3, G=4); converting the integers to color matrices (such as, 1=red, 2=blue, 3=black, 4=green) to form a matrix of layering of individual genomes; inserting artificial cSNPs to the matrix as arbitrary symbolic values 500 and 1000, wherein 500's and 1000's are always paired to represent the ideal layering of genome by orienting known cSNP side by side; and converting the matrix to pixel space with a color mask wherein values under 100 are converted to blue, values of 500 are converted to red, and values of 1000 are converted to green (FIG. 3). The cSNP binary state 0< >1 is red< >green and everything else is blue. Millions of the first generation cSNP genetic images with slight variations are created to train the CANN to recognize the genome, in this case C. elegans.

### Example 2: Creation of Second Generation cSNP Images

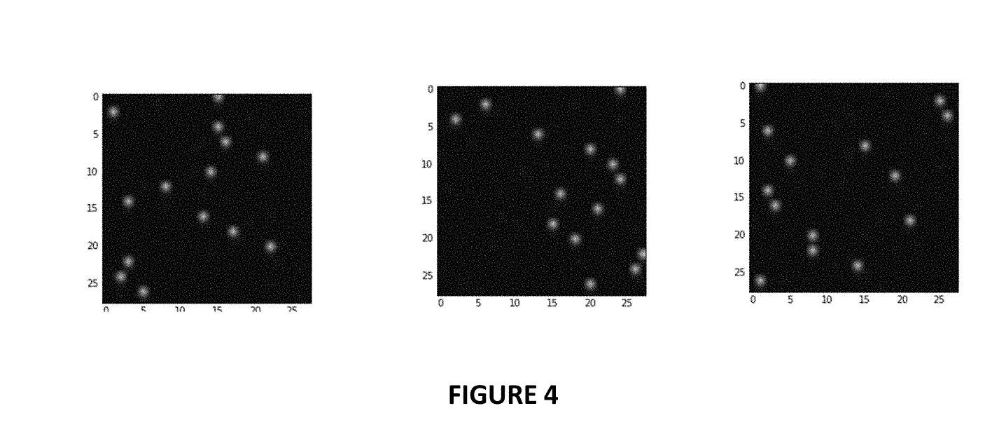

A second generation of cSNP genetic images was created by incorporation of modeling of random errors. (FIG. 4) There are many random SNPs in the canonical C. elegans genome, such as errors caused by sequencing machines, errors in reference genome, and errors in regions which are difficult to cover with deep sequencing. Analysis of cSNPs of the human genomes is even more complex, as in addition to these sources of variability there is also great diversity since humans are not as inbred as, e.g., the N2 laboratory strain of C. elegans. Thus random SNPs were modelled into the method of creating the second generation cSNP genetic image by introducing symbolic values of 100 randomly cSNPs into the genetic image and instructing the color mask to designate these values as pixels of light blue. This modeling of random SNPs allowed the selection against a single neuron that changes color rather than requiring a change in color across two aligned positions. The consequence of introducing random SNPs to the genetic data was to further ratify that state neurons in the fully connected layer were resistant to various types of errors in real sequencing data. cSNPs were sparsely distributed across the second generation genetic images, allowing greater diversity in positioning cSNPs across any given genetic images.

When millions of genetic images were fed into the CANNs, neurons that learned the position of colors within the image was important, and the arbitrary occurrence of two distinct colors which were selected against was minimized, resulting in state neurons that were equally sensitive to genes and regions of the genome with high and low densities of cSNPs and even within genomes with great diversity, such as human genomes.

### Example 3: Generation of Adaptive cSNP Maps with CANNS

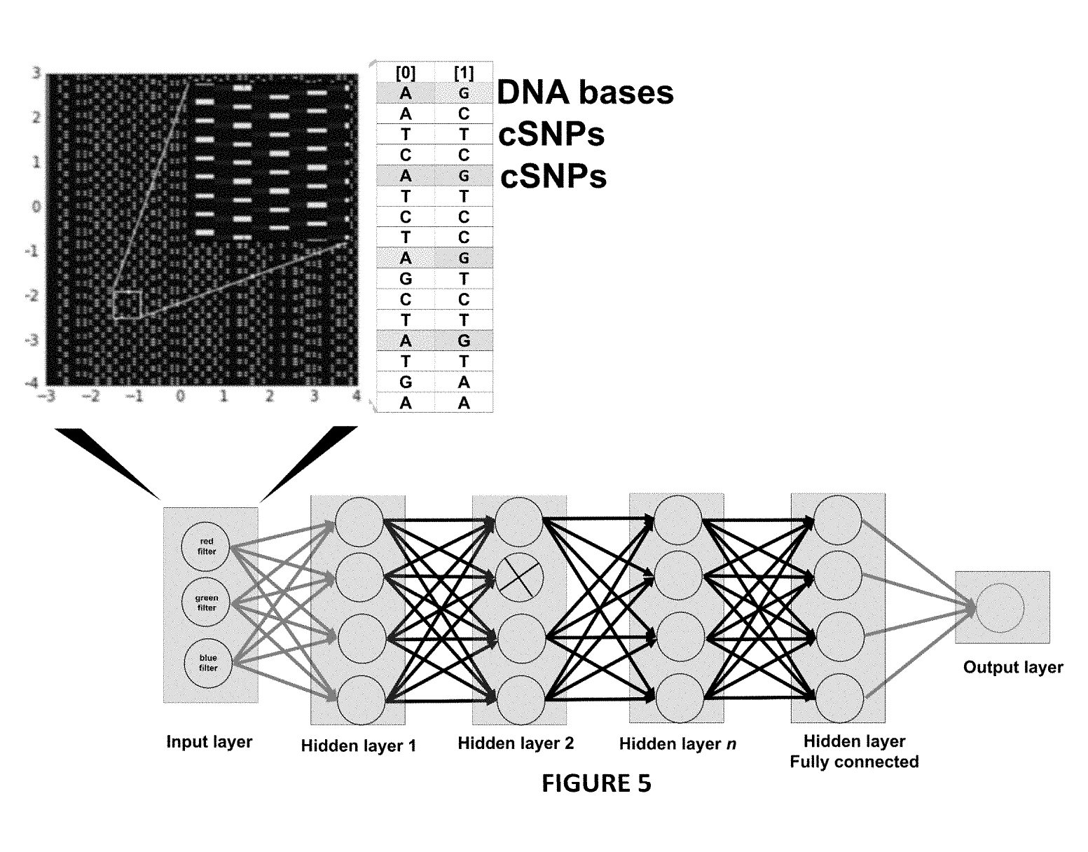

An adaptive cSNP map with genetic images resulted in a CANN-acceptable transformation of whole genome sequencing data. The CANN used in this application was based on the architecture of the pre-existing open-sourced model AlexNet with an input layer to receive whole genome sequencing data, and was trained with genetic images containing cSNPs. The CANNs for generating the cSNP maps comprised at least an input layer, several hidden layers, and an output layer (FIG. 5). cSNP genetic images are fed into the input layer of the CANNs. The CANNs separate the image into component parts of color to feed to a series of hidden layers. At each hidden layer, specific features were extracted and fed into the next layer, thus forming a hierarchical representation of complexity of the original input. Each hidden layer had some neurons randomly inactivated (see FIG. 5, the neuron marked with X) to prevent over-fitting, when neurons become overly sensitive to a subset of neurons from the previous layer.

The last hidden layer of the CANNs was fully connected, i.e., receiving input from every neuron in the previous layer, and outputs to a classification layer. For generating cSNP maps, the fully connected layer was of greater importance than the classification layer. The activations of the neurons in the fully connected layer represented multiplicities of the features to which the neurons in a previous layer were sensitive. For instance, some neurons in the fully connected layer were sensitive to combinations of neurons in previous layers, and some of the neurons learned to activate upon seeing green or red, but not to activate upon seeing blue. These neurons thus activated only when early subsets of neurons observed both green and red, but not blue. These neurons were recognized as “state neurons” due to their sensitivities to the binary state 0< >1 of cSNP in the original sequencing data which was converted to the genetic image by the color mask. However, these state neurons were not sensitive to any particular value of ATCG or the converted integers (1, 2, 3, 4). Therefore, if the blue components of the genetic image were converted to four unique colors to represent their ATCG value, these state neurons were not sensitive to the new colors. State neurons were thus sensitive to the state across values, and activated when data contains cSNPs. This data can be the original C. elegans genome sequencing data or any genome sequencing data, such as sequencing data from human genomes. When whole genome sequencing data from two regions of the world are fed into a CANN containing state neurons, it lead to a pattern of firing neurons to generate a cSNP map to identify cSNPs across entire genomes. The pre-trained CANNs fired neurons at positions where cSNPs occur. The map of the CANN firing is a cSNP map.

While this invention is satisfied by aspects in many different forms, as described in detail in connection with the preferred invention, it is understood that the present disclosure is to be considered as exemplary of the principles of the invention and is not intended to limit the invention to the specific aspects illustrated and described herein. Numerous variations may be made by persons skilled in the art without departure from the spirit of the invention. The scope of the invention will be measured by the appended claims and their equivalents. The abstract and the title are not to be construed as limiting the scope of the present invention, as their purpose is to enable the appropriate authorities, as well as the general public, to quickly determine the general nature of the invention. All references cited herein are incorporated by their entirety for all purposes. In the claims that follow, unless the term “means” is used, none of the features or elements recited therein should be construed as means-plus-function limitations pursuant to 35 U.S.C. § 112, ¶6.

What is claimed is:

1. A convolutional artificial neural networks (CANN) for identifying phenotype-causing nucleic acid sequences in living organisms, wherein the CANN is created by:
extracting features of nucleic acid sequencing data;
converting sequence data of the extracted and stacked nucleic acid sequencing data to symbolic matrices; and
providing the converted symbolic matrices as input to create the CANN.

2. The CANN of claim 1, wherein the features of the nucleic acid sequencing data are extracted using stacking of the sequencing data.

3. The CANN of claim 1, wherein the features of the nucleic acid sequencing data are extracted using pooling of the sequencing data.

4. The CANN of claim 1, wherein the symbolic matrices are visual matrices.

5. The CANN of claim 4, wherein the visual matrices are color matrices.

6. The CANN of claim 1, wherein the sequencing data is converted to symbolic images prior to conversion to symbolic matrices.

7. The CANN of claim 1, wherein the sequencing data comprises sequencing data from two or more cohorts.

8. The CANN of claim 7, wherein the sequencing data comprises sequencing data from three or more cohorts.

9. The CANN of claim 1, wherein the sequencing data comprises intergenerational sequencing data.

10. The CANN of claim 1, wherein the sequencing data comprises ultragenerational sequencing data.

11. The CANN of claim 1, wherein the sequencing data comprises sequencing data of two or more different genetic subgroups.

12. The CANN of claim 1, wherein the sequencing data comprises sequencing data of three or more different genetic subgroups.

13. A method for identifying phenotype-causing nucleic acid sequences in living organisms, comprising:
extracting features of nucleic acid sequencing data;
converting sequence data of the extracted and stacked nucleic acid sequencing data to symbolic matrices;
generating representative symbols of the sequencing data; and
providing the generated representative symbols as input for convolutional artificial neural networks (CANNs) to identify and extract features of genome sequencing data.

14. The method of claim 13, wherein extracting features comprises the step of stacking the sequencing data.

15. The method of claim 13, wherein extracting features comprises the step of pooling the sequencing data.

16. The method of claim 13, wherein the sequencing data is sequencing data of two or more different genetic subgroups.

17. The method of claim 16, wherein the sequencing data is sequencing data of three or more different genetic subgroups.

18. The method of claim 13, wherein the extracted data is converted to symbolic integers prior to conversion to symbolic matrices.

19. The method of claim 13, wherein the symbolic matrices are visual matrices.

20. The method of claim 13, wherein the symbolic matrices are color matrices.

21. A method of creating first generation cSNP genetic images comprising:
stacking nucleic acid sequencing data from one or more individuals from at least two different cohorts;
converting the bases of the nucleic acid sequencing data to symbolic integers;
converting the symbolic integers to symbolic matrices to form a matrix of layering of individual genomes; and
inserting artificial genetic features to the matrix as arbitrary symbolic values that represent the ideal layering of the nucleic acids by orienting known genetic features.

22. The method of claim 21, wherein the symbolic matrices are visual matrices.

23. The method of claim 22, wherein the symbolic matrices are symbolic color matrices.

24. The method of claim 23, wherein the method further comprises converting the matrix to pixel space with a color mask.

25. A system comprising the CANN of claim 1.
